(19) United States
(12) Patent Application Publication
(10) Pub. No.: US 2008/0148679 A1
(43) Pub. Date: Jun. 26, 2008

(54) SYNTHETIC-FIBER REINFORCED WINDOW COMPONENT

(76) Inventor: Ray E. Gilbert, Bolckow, MO (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/847,889

(22) Filed: Aug. 30, 2007

Related U.S. Application Data
(60) Provisional application No. 60/823,985, filed on Aug. 30, 2006.

(51) Int. Cl. E06B 3/22

(52) U.S. Cl. 52/656.5

(57) ABSTRACT

The present invention provides an improved synthetic-fiber reinforced window component that provides additional thermal efficient properties without a reduction in strength, provides resistance to temperature conduction and wind deflection of the window component, and is adequate or suitable for screw retention of hardware. The inventive synthetic-fiber reinforced window component includes a sash for retaining window glass, the sash defining at least one hollow, and a solid reinforcement profile nested within the hollow. The profile may comprise first and second side walls and a transverse wall extending between the first and second side walls. The profile may include at least one synthetic, organic fiber strand embedded within the profile proximate the intersection of the first side wall and the transverse wall. The fiber strands may extend in the longitudinal direction of the profile. The present invention further includes a reinforcement for a window component comprising a profile configured for insertion into a hollow of a window component.

This application claims the benefit of U.S. Provisional Patent No. 60/823,985 filed Aug. 30, 2006, hereby incorporated by reference in its entirety.

### BACKGROUND OF INVENTION

a. Field of Invention

The invention relates generally to a synthetic-fiber reinforced window component, including a synthetic-fiber reinforced profile configured for insertion in a hollow of a window sash.

b. Description of Related Art

In order to provide adequate structural reinforcement to window components (such as vinyl window sashes), a metal is used for both reinforcement and fastening of locking hardware in a secure base. Exemplary metals may include aluminum or steel. However, the use of metal causes an increase in thermal conduction, thereby lessening the energy efficiency of window components reinforced with metals. In some other instances, window manufacturers may use a glass-filled (e.g., fiberglass) polyester resin composite reinforcement. However, the glass-filled polyester resin composite reinforcement is not adequate or suitable for screw retention of hardware.

Accordingly, there remains a need for a window component reinforcement that minimizes and/or eliminates these deficiencies in the prior art.

### SUMMARY OF INVENTION

The inventive synthetic-fiber reinforced window component may include a sash for retaining window glass, the sash defining at least one hollow, and a solid reinforcement profile nested within the hollow. The profile may comprise first and second side walls and a transverse wall extending between the first and second side walls. The profile may include at least one synthetic, organic fiber strand embedded within the profile proximate the intersection of the first side wall and the transverse wall. The profile may further include at least one synthetic, organic fiber strand embedded within the profile proximate the intersection of the second side wall and the transverse wall. The fiber strands may extend in the longitudinal direction of the profile.

The present invention may further include a reinforcement for a window component comprising a profile configured for insertion into a hollow of a window component. The profile may comprise first and second side walls and a transverse wall extending between the first and second side walls. A first synthetic, organic fiber strand may be embedded within the profile proximate an intersection of the first side wall and the transverse wall. A second synthetic, organic fiber strand may be embedded within the profile proximate an intersection of the second side wall and the transverse wall. The first and second fiber strands may extend in the longitudinal direction of the profile.

The invention solves the problems and overcomes the deficiencies of the prior window component reinforcements. The improved synthetic-fiber reinforced window component is advantageous as compared to conventional reinforced window components. The improved synthetic-fiber reinforced window component may provide additional thermal efficient properties to window components (e.g., vinyl window components) without a reduction in strength, thereby allowing the lowest possible thermal U-Value ratings while maintaining sufficient strength. In other words, the improved synthetic-fiber reinforced window component may optimize thermal properties of the reinforced window sash. The improved synthetic-fiber reinforced window component may also be adequate or suitable for screw retention of hardware. The improved synthetic-fiber reinforced window component may further provide resistance to temperature conduction and wind deflection of the component.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawing, which is included to provide a further understanding of the invention and are incorporated in and constitute a part of this specification, illustrate an exemplary embodiment of the invention and together with the detailed description serve to explain the principles of the invention. In the drawings:

FIG. 1 is a cross-sectional view of a synthetic-fiber reinforced window component in accordance with the present invention.

### DETAILED DESCRIPTION OF THE PREFERRED EMBODIMENT

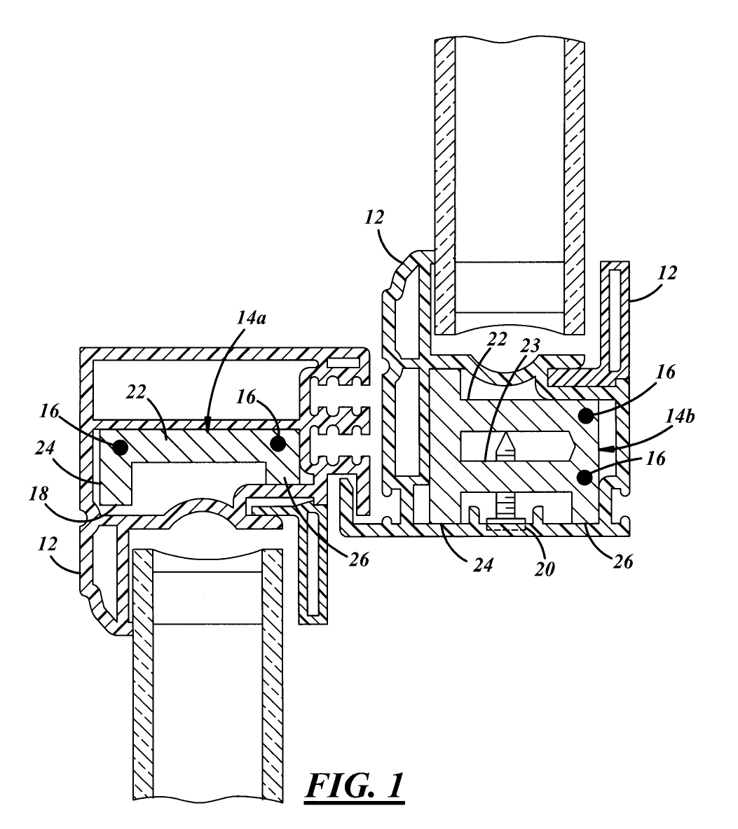

Referring now to the drawings wherein like reference numerals designate corresponding parts throughout the several views, FIG. 1 illustrates a synthetic-fiber reinforced window component in accordance with the present invention. The synthetic-fiber reinforced window component may include window extrusion 12, reinforcement profiles 14a, 14b, and synthetic fiber strands 16.

Window extrusion 12 is provided as a structural window component. Window extrusion 12 may comprise a window sash for holding and securing the window glass. Window extrusion 12 may comprise vinyl or other composite. Window extrusion 12 may include one or more hollows 18.

Hollows 18 are provided in window extrusion 12. Hollows 18 may be generally rectangular in shape. Although a rectangular shape is described in detail, it is understood by those of ordinary skill in the art that various other shapes may be utilized and remain within the spirit and scope of the invention.

Reinforcement profiles 14a, 14b are provided to fit (e.g., nest) within one or more of hollows 18 of window extrusion 12 for supporting window extrusion 12. Profiles 14a, 14b may comprise glass-filled polyurethane profiles. Profiles 14a, 14b may comprise glass-filled (e.g., fiberglass) soy resin based polyurethane profiles. Profiles 14a, 14b are configured for insertion into hollows 18. In particular, profiles 14a, 14b may be sized so as to extend approximately the height and width and length of hollows 18. Profiles 14a, 14b may be fastened in place as locking hardware is secured. For example, as shown in FIG. 1, a fastener 20 may be used to secure profile 14a, 14b to window extrusion 12. Fastener 20 may comprise a screw or any other fastener conventional in the art. In an exemplary embodiment, profile 14a may have a generally C-shaped cross section with an extending (e.g., transverse) wall 22 disposed between two side walls 24, 26. In another exemplary embodiment, profile 14b may comprise two extending (e.g., transverse) walls 22, 23 disposed between two side walls 24, 26. Although these shapes for profiles 14a, 14b are mentioned in detail, it is understood by those of ordinary skill in the art that various shapes may be utilized and remain within the spirit and scope of the invention.

Synthetic fiber strands 16 are provided to decrease deflection of window extrusion 12. Synthetic fiber strands 16 may thereby maintain the optimum strength characteristics of reinforced window components or extrusions without negatively affecting energy efficiency. Synthetic fiber strands 16 may comprise synthetic fibers, such as those sold by DuPont under the trademark KEVLAR®. Synthetic fiber strands 16 may comprise manmade organic fibers. Synthetic fiber strands 16 may comprise para-aramide (aromatic polyamide) fibers. Synthetic fiber strands 16 may comprise poly-paraphenylene terephthalamide fibers.

Fiber strands 16 are configured to be embedded within profiles 14. Synthetic fiber strands 16 may be positioned near an intersection of one of extending (e.g., transverse) walls 22, 23 and one of side walls 24, 26 of profiles 14a, 14b. Accordingly, fiber strands 16 may be positioned proximate an edge of profile 14a, 14b. For example, fiber strands 16 may be positioned proximate an intersection of extending (e.g., transverse) wall 22 and side wall 24 and proximate an intersection of extending (e.g., transverse) wall 22 and side wall 26 in profile 14a. For another example, fiber strands 16 may be positioned proximate an intersection of extending (e.g., transverse) wall 22 and side wall 24 in profile 14b. Fiber strands 16 may also be positioned proximate an intersection of extending (e.g., transverse) wall 22 and side wall 26 in profile 14b. Fiber strands 16 may also be positioned proximate an intersection of extending (e.g., transverse) wall 23 and side wall 26, for example, in profile 14b. Although these positions are mentioned in detail, it is understood by those of ordinary skill in the art that various positions for fiber strands 16 may be utilized and remain within the spirit and scope of the invention. Although two or three fiber strands 16 for use in each profile 14a, 14b are mentioned in detail and illustrated, it is understood by those of ordinary skill in the art that fewer or more fiber strands 16 may be utilized and remain within the spirit and scope of the invention. Fiber strands 16 may extend in the longitudinal direction of profile 14a, 14b.

The inventive synthetic-fiber reinforced window component is advantageous as compared to conventional window components. The inventive synthetic-fiber reinforced window component provides additional thermal efficient properties to window components (e.g., vinyl window components) without a reduction in strength, thereby allowing the lowest possible thermal U-Value ratings while maintaining sufficient strength. The improved synthetic-fiber reinforced window component is also adequate or suitable for screw retention of hardware. The inventive synthetic-fiber reinforced window component further provides resistance to temperature conduction and wind deflection of the window component.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A synthetic-fiber reinforced window component, comprising:
a sash for retaining window glass, said sash defining at least one hollow;
a solid reinforcement profile nested within said hollow, said profile comprising first and second side walls and a transverse wall extending between said first and second side walls; and
a first synthetic, organic fiber strand embedded within said profile proximate an intersection of said first side wall and said transverse wall, wherein said first fiber strand extends in the longitudinal direction of said profile.

2. A synthetic-fiber reinforced window component in accordance with claim 1, further comprising a second synthetic, organic fiber embedded within said profile proximate an intersection of said second side wall and said transverse wall, wherein said second fiber strand extends in the longitudinal direction of said profile.

3. A synthetic-fiber reinforced window component in accordance with claim 1, wherein said fiber strand comprises a KEVLAR® fiber strand.

4. A synthetic-fiber reinforced window component in accordance with claim 1, wherein said fiber strand comprises a para-aramide (aromatic polyamide) fiber.

5. A synthetic-fiber reinforced window component in accordance with claim 1, wherein said fiber strand comprises a poly-paraphenylene terephthalamide fiber.

6. A synthetic-fiber reinforced window component in accordance with claim 1, wherein said reinforcement profile comprises polyurethane.

7. A synthetic-fiber reinforced window component in accordance with claim 1, wherein said reinforcement profile is retained in said hollow with a fastener.

8. A reinforcement for a window component, comprising:
a solid profile configured for insertion into a hollow of said window component, said profile comprising first and second side walls and a transverse wall extending between said first and second side walls; and
a first synthetic, organic fiber strand embedded within said profile proximate an intersection of said first side wall and said transverse wall, wherein said first and second fiber strands extend in the longitudinal direction of said profile.

9. A reinforcement for a window component in accordance with claim 8, further comprising a second synthetic, organic fiber strand embedded within said profile proximate an intersection of said second side wall and said transverse wall, wherein said second fiber strand extends in the longitudinal direction of said profile.

10. A reinforcement for a window component in accordance with claim 8, wherein said fiber strand comprises a KEVLAR® fiber strand.

11. A reinforcement for a window component in accordance with claim 8, wherein said fiber strand comprises a para-aramide (aromatic polyamide) fiber.

12. A reinforcement for a window component in accordance with claim 8, wherein said fiber strand comprises a poly-paraphenylene terephthalamide fiber.

13. A reinforcement for a window component in accordance with claim 8, wherein said reinforcement profile comprises polyurethane.

14. A reinforcement for a window component in accordance with claim 8, wherein said reinforcement profile is retained in said hollow with a fastener.

15. A synthetic-fiber reinforced window component, comprising:
a sash for retaining window glass, said sash defining at least one hollow;
a solid reinforcement profile nested within said hollow, said profile comprising first and second side walls and a transverse wall extending between said first and second side walls;
at least one synthetic, organic fiber strand embedded within said profile, wherein said at least one fiber strand extends in the longitudinal direction of the profile.

16. A synthetic-fiber reinforced window component in accordance with claim 15, wherein said fiber strand comprises a KEVLAR® fiber strand.

17. A synthetic-fiber reinforced window component in accordance with claim 15, wherein said fiber strand comprises a para-aramide (aromatic polyamide) fiber.

18. A synthetic-fiber reinforced window component in accordance with claim 15, wherein said fiber strand comprises a poly-paraphenylene terephthalamide fiber.

19. A synthetic-fiber reinforced window component in accordance with claim 15, wherein said reinforcement profile comprises polyurethane.

20. A synthetic-fiber reinforced window component in accordance with claim 15, wherein said reinforcement profile comprises glass-filled polyurethane.
